(19) United States
(12) Patent Application Publication
(10) Pub. No.: US 2010/0282277 A1
(43) Pub. Date: Nov. 11, 2010

(54) Method For Cleaning Fouled Vessels In The Parraffinic Froth Treatment Process

(76) Inventors: Tapantosh Chakrabarty, Calgary (CA); Ken Sury, Calgary (CA)

Correspondence Address: EXXONMOBIL UPSTREAM RESEARCH COMPANY, P.O. Box 2189, (CORP-URC-SW 359), Houston, TX, 77252-2189, US

(21) Appl. No.: 12/599,239

(22) PCT Filed: May 29, 2008
(86) PCT No.: PCT/US08/06782

§ 371 Date: Feb. 24, 2010

(30) Foreign Application Priority Data
Jun. 26, 2007 (CA) 2592725

(51) Int. Cl. B08B 9/00

(52) U.S. Cl. 134/22.1

(57) ABSTRACT

A method of cleaning fouled vessels in the paraffinic froth treatment process (PFT). The foulant comprises asphaltenes. Foulant is at least partially removed from a surface of a vessel or conduit used in a PFT process by spraying a liquid against the foulant on the surface to physically remove at least a portion of the foulant from the surface. The liquid may be a PFT-compatible liquid, water, or a combination thereof. The method may be effected in the substantial absence of a foulant-dissolving agent.

### FIELD OF THE INVENTION

This application claims priority from Canadian Patent Application number 2,592,725 which was filed on 26 Jun. 2007, which is incorporated herein by reference.

The present invention relates generally to a method of cleaning fouled vessels in the paraffinic froth treatment process.

### BACKGROUND OF THE INVENTION

In the field of bitumen extraction from mined oil sands, solvent froth treatment may be used. Generally, oil sands are mined, bitumen is extracted from the sands using water, and bitumen is separated as a froth comprising bitumen, water, solids and air. In certain froth treatment processes, naphtha is used as the solvent to dilute the froth before separating the product bitumen by centrifugation. In other cases, paraffinic froth treatment (PFT) is used where a paraffinic solvent, for instance a mixture of iso-pentane and n-pentane, is used to dilute the froth before separating the product bitumen by gravity. Where paraffinic solvent is used, a portion of the asphaltenes in the bitumen is also rejected by design in the PFT process thus achieving solid and water levels that are lower than those in the naphtha-based froth treatment (NFT) process. A PFT process typically employs at least three units: a froth separation unit (FSU), a solvent recovery unit (SRU) and a tailings solvent recovery unit (TSRU). An example of a PFT process is described below. During a PFT process, foulant, which comprises asphaltenes, may form and build on one or more surfaces of the FSU or other vessel or conduit used in the PFT process. The foulant may build up to a thickness at which it interferes with the normal operation of the process. The vessel or conduit should then be cleaned.

Various chemical methods have been disclosed to clean the walls of tanks and the like of hydrocarbon foulant that may include asphaltenes. U.S. Patent Publication No. 2006/0042661 (Meyer et al.) describes a method of cleaning a petroleum storage tank using a foulant-dissolving agent, followed by a water wash. In particular, the publication relates to a method for removing sludge from a petroleum storage tank based on a two-step approach utilizing an agent to dissolve organic components of the sludge followed by a water wash to remove inorganic materials. Sludges comprise both organic-based solids (e.g. waxes and asphaltenes) as well as inorganic-based solids (known to exist as salts such as chlorides, carbonates, and oxides). The dissolved material can then be processed and recovered in the refinery using conventional refining operations. A water wash following removal of the organic materials is said to be effective to remove the inorganic materials that can then be disposed of without the complications of having to treat the oily organics along with them. A beneficial aspect of the method is said to be mixing and heating to improve the dissolution of soluble materials in both steps of the process. Thus, the asphaltenes are removed by dissolving the foulant.

Conventional approaches to cleaning asphaltene-laden vessels are to use a dissolving agent in an attempt to break down the asphaltenes. Such dissolving methods suffer from various disadvantages as exemplified by the Comparative Examples below. A foulant-dissolving agent as used herein includes an agent that dissolves, disperses, or breaks apart foulant comprising asphaltenes and may include a dispersant or a surfactant.

### SUMMARY OF THE INVENTION

It is an object of the present invention to obviate or mitigate at least one disadvantage of previous methods.

Generally, the present invention provides a method of cleaning fouled vessels in the paraffinic froth treatment process (PFT). The foulant comprises asphaltenes. Foulant is at least partially removed from a surface of a vessel or conduit used in a PFT process by spraying a liquid against the foulant on the surface to physically remove at least a portion of the foulant from the surface. The liquid may be a PFT-compatible liquid, water, or a combination thereof. The method may be effected in the substantial absence of a foulant-dissolving agent.

In a first aspect, the present invention provides a method of removing at least a portion of foulant, the foulant comprising asphaltenes, from a surface of a vessel or conduit used in a paraffinic froth treatment (PFT) process, the method comprising spraying a liquid against the foulant to physically remove at least a portion of the foulant from the surface, wherein the liquid is a PFT-compatible liquid, water, or a combination thereof. In an embodiment, the method is effected in the substantial absence of a foulant-dissolving agent.

In another aspect, the present invention provides a method of removing at least a portion of foulant, the foulant comprising asphaltenes, from a surface of a vessel or conduit used in a paraffinic froth treatment (PFT) process, the method comprising spraying a liquid against the foulant on the surface to physically remove at least a portion of the foulant from the surface, wherein the method is effected in the substantial absence of a foulant-dissolving agent.

In embodiments of the invention, the following features may be present.

The liquid may be a PFT-compatible liquid, a paraffinic solvent from the PFT process, or a C₃ to C₅ paraffinic solvent. The paraffinic solvent may be from a tailings solvent recovery unit (TSRU) used in the PFT process, a solvent recovery unit (SRU) used in the PFT process, or a solvent storage unit used in the PFT process. Such spraying may be effected intermittently or continuously during partially suspended operation of the vessel or conduit.

The PFT process may comprise the use of a first froth separation unit (FSU-1) in series with a second subsequent froth separation unit (FSU-2), the liquid may be a PFT-compatible liquid, the PFT-compatible liquid may be an overflow stream from FSU-2. Such spraying may be effected intermittently or continuously during partially suspended operation of the vessel or conduit.

The liquid may comprise water. The liquid may comprise raw water, PFT recycle water, PFT process water, or PFT tailings water. The liquid may comprise water and a PFT-compatible liquid as described herein. The spraying may be effected while operation of the vessel or conduit is suspended. The method may further comprise spraying another liquid against the foulant on the surface while operation of the vessel or conduit is suspended to physically remove at least a portion of foulant from the surface. The another liquid may comprise water. The another liquid may comprise raw water, PFT recycle water, PFT process water, or PFT tailings water.

The foulant may comprise water, paraffinic solvent, inorganics, and non-volatile hydrocarbons comprising asphaltenes. The foulant may comprise 5-80 percent water and paraffinic solvent, 1-80 percent inorganics, 1-90 percent non-volatile hydrocarbons comprising asphaltenes, all by weight. The foulant may comprise about 46-50 percent water and paraffinic solvent, about 24-46 percent inorganics, and about 14-26 percent non-volatile hydrocarbons comprising asphaltenes, all by weight. The foulant may comprise between 7 and 40 percent asphaltenes, by weight. The inorganics may comprise quartz, alumino-silicates, carbonates, FeₓS_{y}, where x is from 1 to 2 and y is from 1 to 3, and titanium-rich minerals. A major amount by number of the inorganics may be present in particulates of less than 1 μm in size.

Spraying may be effected at a pressure of 0.2 to 8.0 MPag, or 1.5 to 4.0 MPag. Spraying may be effected at a temperature of 0 to 100° C., or of 1 to 30° C.

The method may be effected in the substantial absence of steam injection.

The method may further comprise removing foulant, which has been removed from the surface, from the vessel or conduit.

Spraying may be effected through nozzles in walls of the vessel or conduit and/or from within the vessel's or the conduit's cavity outwardly toward the surface of the conduit or the vessel.

The PFT process may be a low- or high-temperature process, characterized by a temperature of 15 to 100° C.

The vessel is may be a froth separation unit (FSU) used in the PFT process. The surface may be a launder area of the FSU.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic of a PFT process;

FIGS. 2a and 2b are scanning electron microscope (SEM) photographs of PFT foulants;

FIG. 3 is photograph of a launder area (cleaned using a QuickTurn™) and a settler section (not cleaned) treatment of FSU-2, as described in Comparative Example A;

FIGS. 4a and 4b are photographs of FSU-2 before cleaning (FIG. 4a) and after cleaning with EC-5000™ (FIG. 4b), as described in Comparative Example B;

FIGS. 5a to 5c are photographs of the FSU-2 launder area before (FIG. 5a), during (FIG. 5b) and after (FIG. 5c) cleaning by an embodiment of the present invention, as described in Example 1;

FIG. 5d is a photograph of the foulant collected as a slurry in a pail, as described in Example 1;

FIGS. 6a to 6d are photographs of a launder wall before (FIG. 6a), during (FIG. 6b) and after (FIG. 6c) cleaning as described in Example 2;

FIGS. 7a and 7b are photographs of effluent slurry from cleaning FSU-2 (FIG. 7a) and collected slurry from cleaning FSU-2 (FIG. 7b), as described in Example 3;

FIGS. 8a and 8b are photographs of the settler wall before (FIG. 8a) and after (FIG. 8b) cleaning FSU-2, as described in Example 3;

FIG. 9 is a photograph of effluent slurry from cleaning FSU-1, as described in Example 3; and

FIGS. 10a and 10b are photographs of the settler wall before (FIG. 10a) and after (FIG. 10b) cleaning FSU-1, as described in Example 3.

### DETAILED DESCRIPTION

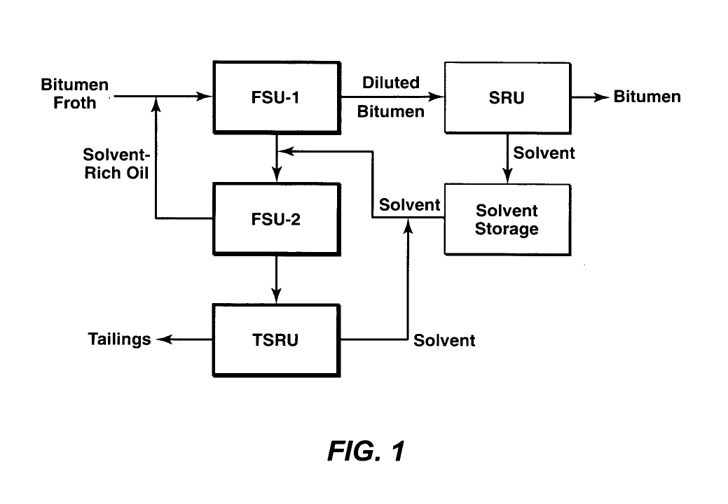

An example of a PFT process will now be described with reference to FIG. 1. Solvent is mixed with the feed froth counter-currently in the FSU, or as shown in FIG. 1, in two stages (FSU-1 and FSU-2). In FSU-1, the froth is mixed with a solvent-rich oil stream from FSU-2. The temperature of FSU-1 is maintained at about 60 to 80° C., or about 70° C. and the target solvent to bitumen ratio is about 1.4:1 to 2.2:1 by weight or about 1.6:1 by weight. The overflow from FSU-1 is the diluted bitumen product and the bottom stream from FSU-1 is the tailings comprising water, solids (inorganics), asphaltenes, and some residual bitumen. The residual bitumen from this bottom stream is further extracted in FSU-2 by contacting it with fresh solvent, for example in a 25:1 to 30:1 by weight solvent to bitumen ratio at, for instance, 80 to 100° C., or about 90° C. The solvent-rich overflow from FSU-2 is mixed with the fresh froth feed as mentioned above. The bottom stream from FSU-2 is the tailings comprising solids, water, asphaltenes, and residual solvent. Residual solvent is recovered prior to the disposal of the tailings in the tailings ponds. Such recovery is effected, for instance, using a tailings solvent recovery unit (TSRU), a series of TSRUs or by another recovery method. Typical examples of operating pressures of FSU-1 and FSU-2 are respectively 550 kPag and 600 kPag. FSUs are typically made of carbon-steel but may be made of other materials. In such a process, significant fouling has been observed in FSU-2, and to a lesser extent in FSU-1. The foregoing is only an example of a PFT process.

As discussed above, conventionally, asphaltene-laden vessels have been cleaned by dissolving the asphaltenes by a chemical (e.g. a dispersant) or a mixture of specialty chemicals.

As discussed below in Comparative Examples 1 and 2, cleaning of an asphaltene-laden FSU using chemicals showed limited success. In particular, during evaluation of these chemicals, it was noted that chemical cleaning took much preparation, several hours of cleaning, required steam injection in the case of one chemical, and required post-cleaning rinsing of the vessels with water in all cases to eliminate the residual chemicals that might adversely affect the PFT process performance. It was also noted that even after using a substantial amount of chemicals, the foulant removal was not complete and even after rinsing with a copious amount of water, a thin layer of foulant remained with the dissolved chemical(s).

During these tests, it was also noted that the rate of chemical cleaning was hindered by the slow lateral diffusion of the chemical into the foulant matrix. It was also noted that chunks of the foulant fell to the bottom of the vessel during cleaning as these were loosely attached to the vessel walls. It was recognized that some amount of lateral force would be required to allow faster chemical penetration into the foulant matrix. As a precursor to a test for promoting faster chemical penetration, another test was first carried out in which a water jet was allowed to impinge on the foulant in the wall. The cleaning in this precursor test was unexpectedly superior to the chemical cleaning in terms of cleaning effectiveness, time, cost and eliminating environmental issues and interference with the PFT process performance.

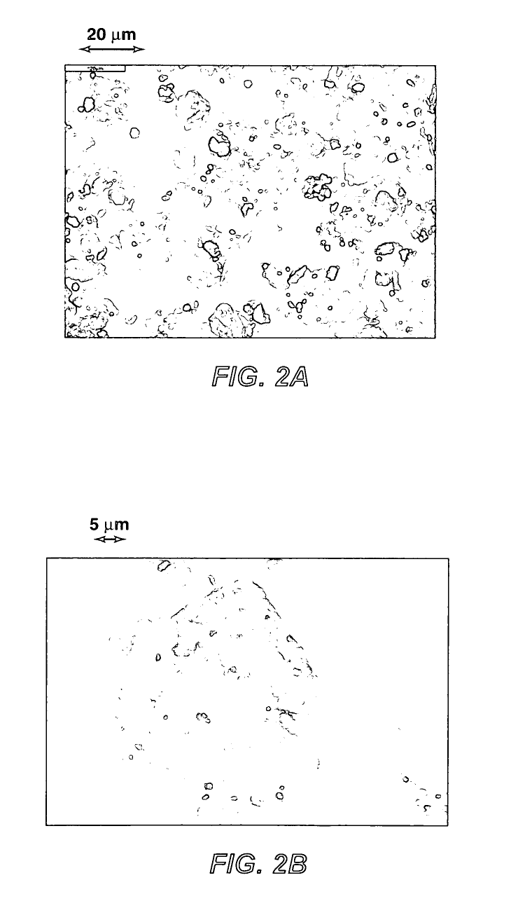

During testing, the foulants of an FSU-1 and an FSU-2 (in a system as generally shown in FIG. 1) were analyzed. The foulant of FSU-1 typically comprise 46 percent volatiles (comprising water and pentane), 40 percent inorganics (comprising quartz, alumino silicates, carbonates, FeₓS_{y}, and titanium-rich minerals) and 14 percent NVHC (non-volatile hydrocarbons essentially comprising asphaltenes), all by weight. The foulant of FSU-2 typically consisted of 50 percent volatiles (comprising water and pentane), 24 percent inorganics (comprising quartz, alumino silicates, carbonates, FeₓS_{y}, and titanium-rich minerals) and 26 percent NVHC (non-volatile hydrocarbons essentially comprising asphaltenes), all by weight. The foulant of FSU-2 had more asphaltenes than did the product bitumen. The H:C atomic ratio in the foulant was 1.2:1 to 1.3:1 compared to 1.35:1 in bitumen. Inorganics (quartz, alumino silicates, FeₓS_{y}, carbonates and TiO₂) identified in the foulant are similar to those typically present in the oil sands from which the bitumen has been extracted and made into a froth. The majority, by weight, of the inorganic particulates is less than 1 μm in size. FIGS. 2a and 2b are scanning electron microscope (SEM) photographs showing evidence that the inorganics are held together by asphaltenes. In FIGS. 2a and 2b, the inorganics in the PFT foulant are light-colored and are glued together by the dark-coloured asphaltenes. It is the presence of these asphaltenes, acting as a glue, that have led those skilled in the art to use asphaltenes-dissolving or dispersing chemical(s) in cleaning the fouled vessels in the PFT process.

In one embodiment, a method of cleaning a fouled vessel in the PFT process comprises spraying liquid against the foulant on the surface of the vessel or conduit (the operation of which has been suspended), thereby physically removing foulant from the surface, slurrifying the solids in the injected liquid and removing the slurry from the bottom of the vessel. The expression “physically removing” means separating foulant from the surface where dissolution of the foulant through the use of a dissolving agent does not play a major role. In this embodiment, the vessel may also be drained or at least partially drained prior to cleaning. In one embodiment, the vessel is an FSU. The term “surface” as used herein is not limited in the orientation of the surface. For instance, cleaning of a wall, floor, or ceiling of a vessel is within scope. The temperature of the liquid is not critical. In certain embodiments the liquid is injected at a temperature of 0 to 100° C., 0 to 50° C., 0 to 40° C., 0 to 30° C., 0 to 25° C., 0 to 20° C., or 1 to 30° C. While using a temperature of well above ambient is within the scope of certain embodiments, it is presently believed that at a certain point, the effectiveness of the liquid spray may be compromised due to softening of the foulant causing increased adhesion of the foulant to the surface of the vessel. Also, generally, warmer liquid is more expensive. Whereas some conventional chemical cleaning uses hot water or steam, along with a chemical, to accelerate dissolution of asphaltenes, as stated above, the temperature of the liquid in embodiments of the instant invention is not per se limited. The broader range of acceptable liquid temperature is unlike conventional cleaning methods since the cleaning in this process is not by asphaltene dissolution, but rather by physical removal. A lower liquid temperature is in fact advantageous in practicing this process by keeping the asphaltenes semi-solids, thereby reducing their propensity to stick to a surface. Compared to chemical cleaning with steam, this process may be more economical as neither a chemical nor energy to make steam or hot water is required. In certain embodiments, the liquid is injected at a pressure of about that of municipally supplied water or higher, or 0.2 to 8.0 MPag, 1.0 to 6.0 MPag, 1.5 to 4.0 MPag, 1.5 to 3.0 MPag, 1.5 to 2.5 MPag, 1.7 to 2.4 MPag, 1.8 to 2.3 MPag, 1.9 to 2.2 MPag, about 2.0 MPag, or about 2.1 MPag.

Where the vessel is suspended in operation to effect cleaning, the liquid sprayed to remove the foulant from the surface of the vessel need not be compatible with the PFT process. That is, following such cleaning, the liquid may be partially or substantially removed from the vessel to the extent desired considering the degree of non-compatibility of the liquid with the PFT process. Therefore, an aqueous liquid, water, or another liquid that can be removed to an extent acceptable to the operation of the PFT process may be used. Examples of other liquids that may be used include, but are not limited to, raw water (e.g. municipal water, stream water, or aquifer water), recycle water, process water, and water from tailings. The recycle water, process water, or tailings water may be from the same PFT process, another PFT process, or from a non-PFT process. A non-PFT-compatible liquid is distinguished herein from a foulant-dissolving agent, for instance as used in the Comparative Examples, since a non-PFT-compatible liquid is not effective in dissolving foulant. Use of a chemical dissolving agent requires extensive water wash to ensure that the chemicals are removed. The liquid may alternatively, or additionally, be a PFT-compatible liquid as described below. As an alternative to a liquid or in addition to a liquid, an inert gas can be used (e.g. nitrogen).

Where the vessel is cleaned during partially suspended, or reduced, operation, the liquid sprayed to remove the foulant from the surface of the vessel should be compatible with the PFT process. That is, the liquid should not interfere with the operation of the vessel to be cleaned (e.g. the FSU) or surrounding processes to an unacceptable extent. In particular, it should not, to an unacceptable extent, affect the extent of asphaltenes rejection by the PFT process solvent, adversely affect the water and solid concentration targets in the bitumen product, interfere in recovery of the process solvent by distillation, or affect the quality of bitumen product if it is not completely removed from the bitumen. Examples of “partially suspended operation” include: (a) where the operation is suspended but the vessel is not drained before the operation is restarted; and (b) where the operation of one of the FSUs (e.g. FSU-2) is suspended and another FSU (e.g. FSU-1) remains in operation. The term “liquid” as used herein is not limited to pure liquid, and there may be some solids present. Examples of PFT-compatible liquids include a paraffinic solvent from the PFT process. The paraffinic solvent may be, for instance, from a tailings solvent recovery unit (TSRU) used in the PFT process, a solvent recovery unit (SRU) used in the PFT process, or a solvent storage unit used in the PFT process. The paraffinic solvent may comprise the same paraffinic solvent used in the PFT process, and may also comprise other paraffinic solvents (e.g. C₃, C₄, or C₅ paraffinic solvent). Another example of liquid that can be sprayed as described above, is the overflow stream from a second or subsequent FSU (e.g. FSU-2). Testing has shown that such a stream may comprise about 97 percent solvent, by volume.

The method may be applied to both low- and high-temperature PFT processes, covering a temperature range of, but not restricted to, 15 to 100° C.

Examples of liquid pressures have been provided above and may be moderate and may be adjusted depending on the conditions of the foulant and its interaction with the vessel surface. Supply liquid pressure can be raised to the target cleaning pressure in various ways, including but not limited to, a single pump, or more than one pump in series.

Spraying liquid against the foulant may be achieved in a number of ways. In one embodiment, arrays of nozzles with orifices are used to convert the pressure energy into a liquid jet that impinges on the foulant and removes it from the vessel surface. In one embodiment, the nozzles are placed or used only in the upper part of an FSU vessel (commonly referred to as the hydrocarbon leg) where most of the fouling occurs on the walls. The lower part of the FSU (commonly referred to as the water leg) typically has significantly less foulant on the surface and may not require cleaning, or may require less cleaning.

The direction of the impingement can be either from inside the vessel towards the foulant on the surface or from the backside of the foulant towards the inside of the vessel. In achieving the former direction of impingement, arrays of nozzles may be placed on a shaft that is lowered inside the drained off vessel; this may be accomplished robotically or automatically. In achieving the latter direction of impingement, arrays of nozzles may be placed around the interior of the vessel walls. In both cases, the nozzles may have swiveling action and may be spaced such that a large area with the foulant is reached. Manual spraying may also be used. The foregoing merely represents examples of spraying and various other ways of spraying may be used. Spraying may be effected from top to bottom, bottom to top, in a radial fashion, or in another manner.

In yet another embodiment, the launder areas of the FSUs are cleaned in the same manner or manually with liquid jets.

In yet another embodiment, draining of the vessels prior to cleaning is either eliminated or its frequency reduced by spraying liquid that is compatible with the PFT process, for instance process solvent, for instance a paraffinic solvent (as described above), for instance at a pressure of 0.2 to 8.0 MPag, 1.0 to 6.0 MPag, 1.5 to 4.0 MPag, 1.5 to 3.0 MPag, 1.5 to 2.5 MPag, 1.7 to 2.4 MPag, 1.8 to 2.3 MPag, 1.9 to 2.2 MPag, about 2.0 MPag, or about 2.1 MPag, from the backside of the foulant through nozzles (e.g. arrays of nozzles). Such spraying may be effected intermittently (e.g. at predetermined time intervals). Unlike water, such a liquid is compatible with the PFT process fluids. In particular, the FSU-2, which experiences more fouling than FSU-1, is particularly suitable to process solvent cleaning because of its high solvent to bitumen ratio (e.g. 25 to 30:1 by weight) and an occasional burst of solvent should not cause any unacceptable process upset. Process upset can also be avoided, or mitigated, according to an embodiment, by restricting the solvent injection to the hydrocarbon leg, where most of the fouling occurs. By implementing this embodiment, the productivity of the PFT can be improved by reducing the frequency of shutdown required for draining and cleaning.

Under the same foulant conditions, the cleaning time (excluding preparation time), in a method according to an embodiment of the present invention, may be much shorter than that in chemical cleaning. An embodied method may mitigate or eliminate concerns related to the residual cleaning of chemicals adversely affecting the PFT performance. An embodied method may also mitigate or eliminate chemical handling, storage and disposal issues. An embodied method may offer a cost-effective and/or easier-to-implement alternative to the conventional chemical cleaning of vessels (e.g. an FSU) in the PFT process. An embodied method may afford a greater degree of foulant removal. An embodied method may afford mitigated interference with the PFT process or in the FSU. An embodied method may afford reduced environmental and/or safety issues.

By using a non-PFT-compatible liquid (e.g. water) (distinguished above from a foulant-dissolving agent) and/or a PFT-compatible liquid, the resultant stream comprising the non-PFT-compatible liquid and/or the PFT-compatible liquid together with foulant may be passed to a TSRU to recover solvent. This is superior to a process where a foulant-dissolving agent is used since a stream resulting from the use of a foulant-dissolving agent cannot easily be passed to a TSRU.

While much of the above description refers to cleaning of a vessel used in a PFT process, cleaning of a conduit used in a PFT process is also in scope.

### Examples

The first two examples (Comparative Examples A & B) show the drawbacks of the conventional chemical cleaning of FSU vessels, while the last three examples (Examples 1 to 3) highlight the superior cleaning by a method of an embodiment of the present invention.

### Comparative Example A

### Conventional Chemical Cleaning of FSU

RTI's QuickTurn™ (from RTI International, Research Triangle Park, N.C.) was selected for evaluation because of its ability to dissolve asphaltenes and reported success in cleaning refinery vessels. The method relies on vapor phase cleaning that allows access of the cleaning solvent to otherwise inaccessible areas. The vaporization of the chemical is accomplished by injecting it with steam. The chemical is terpene-based and mixed with proprietary surfactants for emulsification of the asphaltenes.

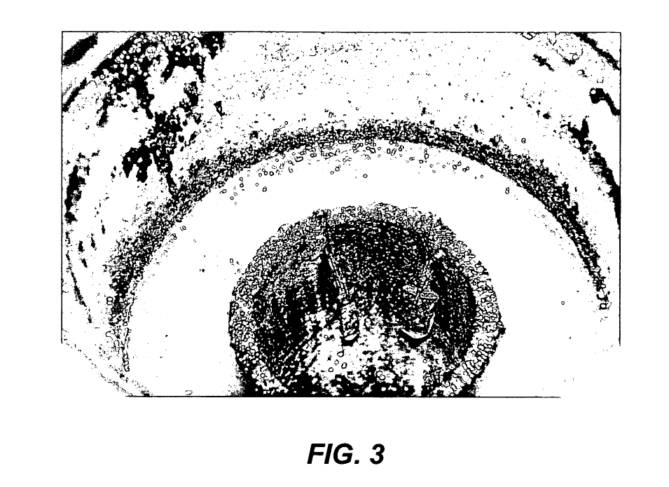

Two tests, one each in FSU-1 and FSU-2, were carried out. The first test was conducted in FSU-2. Prior to the chemical injection, steam was injected alone for 9 minutes at a pressure of 861 kPag to raise the settler temperature to 154° C. QuickTurn™ chemical (17.1 kg) was then injected with steam for 43 minutes followed by 15 minutes of steam injection alone. After cessation of steam injection, the vessel was rinsed with cold water for 43 minutes to remove any residual chemical. The rinsing was followed by a depressurization of the vessel over a period of 11 minutes. The total cleaning time, excluding the time for the test preparation, was 121 minutes. FIG. 3 shows the launder area (cleaned) and settler section (not cleaned) after the QuickTurn™ treatment of FSU-2.

This cleaning test showed that the weir and surrounding area were cleaned to the bare metal, but significant fouling still persisted in the inner wall of the settler pipe section, as seen in FIG. 3.

For the FSU-1 test, the chemical amount was increased from 17.1 kg to 37.1 kg to increase its effectiveness, despite the fact that the foulant build-up in FSU-1 was lower by a factor of three to four than that in FSU-2.

In this test, steam alone at a pressure of 861 kPag was injected for 7 minutes to raise the settler temperature to 154° C. The chemical was then injected with the steam continuously for 41 minutes, followed by steam injection alone for 30 minutes. The duration of steam alone injection was longer than that of the first test in FSU-2.

The cleaning test was concluded after 21 minutes of rinsing with cold water, followed by 7 minutes of depressurization, for a total cleaning time of 106 minutes, excluding the test preparation time.

The results from this test were excellent in that both the weir and the wall of the settler pipe section were clean to the bare metal. Evidently, increasing the chemical dosage by a factor of two over the first test in FSU-2 and increasing the steam-alone soaking period helped the cleaning. However, the amount of chemical is too high to make the process economically attractive. Furthermore, both tests required a lot of logistics to make the steam available. The chemical also requires special handling as it causes reaction upon contact with skin and inhalation.

### Comparative Example B

### Conventional Chemical Cleaning of FSU

Extracted from orange rind by steam distillation, NuWave's EC5000™ (NuWave Soap Company Limited, Wetaskiwin, Alberta, Canada) is a d-limonene with a pleasant orange flavour and is safer to handle than QuickTurn™. It was selected for evaluation based on lab tests that showed its ability to dissolve granular C5-asphaltenes (i.e. asphaltenes that are insoluble in pentane) and clean asphaltenes-coated carbon steel coupons effectively.

In one lab test, 7.5 g of d-limonene dissolved 2.2 g of granular C5-asphaltenes on gentle mixing, creating a solution with 22.5 percent asphaltenes, by weight. In another lab test, d-limonene cleaned an asphaltenes-coated carbon steel coupon. The coupon (5 cm long, 1.3 cm in diameter, 0.32 cm thick) was coated with C5-asphaltenes by immersing it in the tailings (90° C.) generated in the laboratory by contacting a bitumen froth with n-pentane. The asphaltenes depositing on the coupon turned it into a dark-colored piece with a very rough texture. The air-dried coupon was then immersed in about 35 ml of d-limonene at room temperature. Within five minutes of contacting the solvent and upon gentle mixing, the asphaltenes deposit from the coupon dissolved in the d-limonene, leaving a clean, shiny coupon.

A test was then conducted to evaluate the effectiveness of d-limonene in cleaning FSU-2. Prior to the d-limonene test, this vessel had gone though two consecutive 72-hour runs, with no cleaning in between two runs.

The test protocol in evaluating the EC-5000™ called for: filling FSU-2 vessel with 23.2 kg of EC-5000™ and raising the vessel pressure to 138 kPag with nitrogen; recirculating the chemical from bottom to top using a Moyno™ (Moyno Inc., Springfield, Ohio) pump at a rate of 3.4 kg/min for 120 minutes at room temperature (19.4° C.); draining the slurry (d-limonene, solids and dissolved asphaltenes) from the bottom of the vessel after 120 minutes of recirculation; and rinsing the vessel with cold water (21° C.) at a rate of 4 kg/min for 35 minutes and taking water samples every 5 minutes for total organic carbon (TOC) analysis to determine the concentration of the residual chemical.

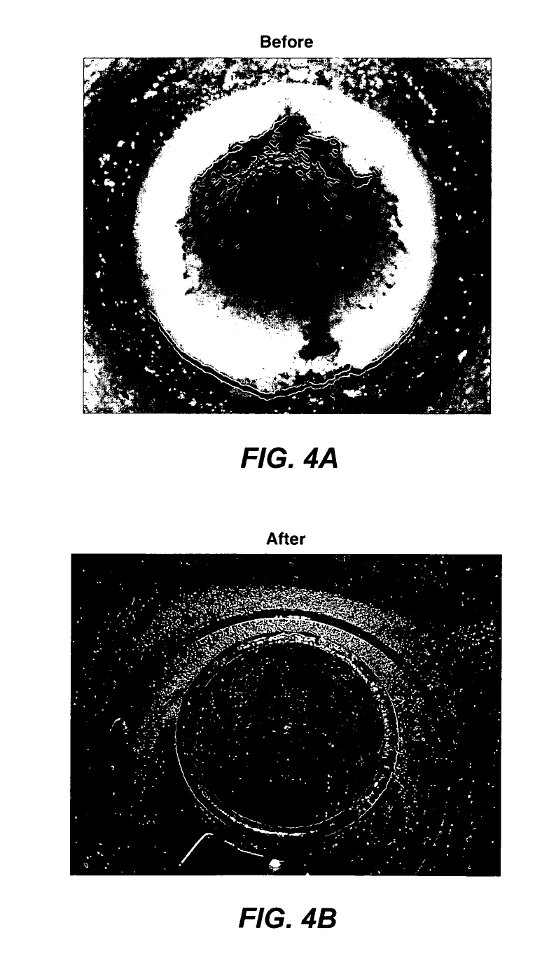

The results from the FSU-2 cleaning with EC-5000™ were as follows: the vessel wall was not completely clean and still had a thin layer of soft asphaltenes, as seen in FIG. 4b (after cleaning), compared to FIG. 4a (before cleaning); ten minutes of rinsing with water reduced the TOC to 11 ppm in the effluent water and 35 minutes of rinsing reduced it to 1.4 ppm; and a significant amount of the foulant was removed from the wall as chunks that collected at the bottom of the vessel.

The following drawbacks were noted in the cleaning of FSU vessels with QuickTurn™ and EC-5000™. RTI's QuickTurn™, to be effective, requires steam, a lot of chemical (37.1 kg to clean a 183 cm long and 10 cm diameter FSU-1 vessel with a 3 mm foulant thickness), 1.5 to 2 hours of cleaning time, excluding preparation time. It also requires special handling and disposal considerations. NuWave's EC-5000™ does not require any steam, however it still leaves some residual solvent in the thin layer of asphaltenes which may adversely affect the PFT performance. It requires a large amount of chemical and several hours to clean, in addition to requiring waste disposal considerations. In both chemicals, the penetration by diffusion into foulant matrix was slow.

### Examples 1 to 3

The following examples illustrate the cleaning of FSU-1 and FSU-2 vessels using a method and/or apparatus of embodiments of the instant invention. They also show how cleaning by this method and/or apparatus overcomes at least certain drawbacks of the conventional chemical cleaning of Comparative Examples A and B.

### Example 1

### Cleaning of FSU-2 Launder Area by a Method of an Embodiment of the Instant Invention

A manual hand-held washer (model MTM, Aura Hydro, Italy; 0 degree angle; 5.0 orifice=57/1000″ opening; Max T: 150° C.; Max. P: 21 MPa; Max Flow: 25 L/min) was used for removing the foulant from the FSU-1 launder base and wall. Municipal water (from Devon, Alberta, Canada) at a temperature of 18 to 20° C. was used for the test. The water pressure was raised to 2.1 MPag using two Moyno^{TM} pumps in series and the water flow rate during cleaning was 5.3 kg/min.

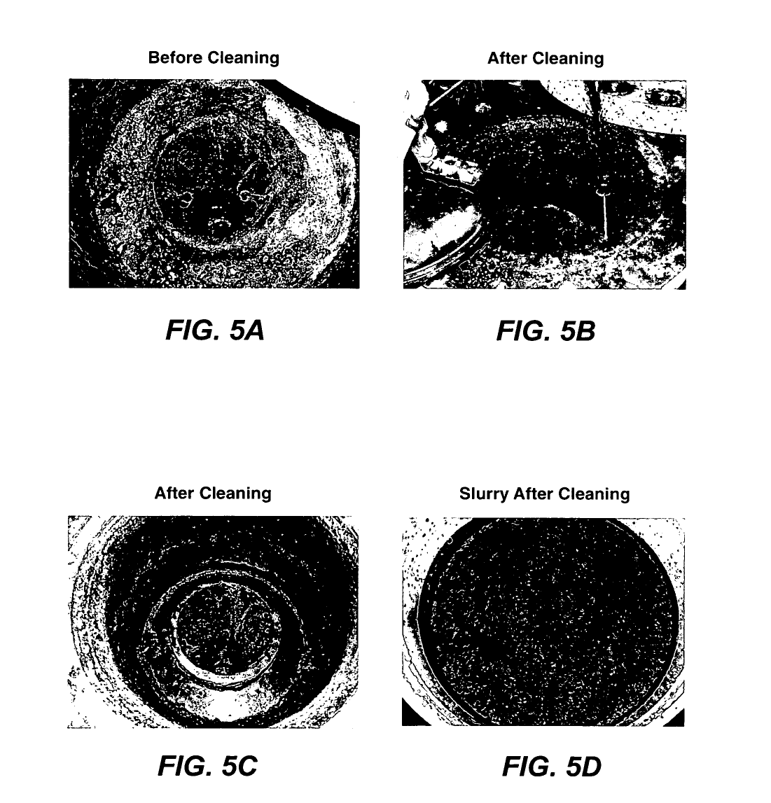

FIGS. 5a to 5c show the FSU-2 launder area before, during and after cleaning by this invention. The water jet (about 1 to 2 mm in thickness) is also shown in FIG. 5b. The launder base and the wall areas were cleaned to the bare metal in only 3.5 minutes, compared to hours needed in the chemical cleaning methods in Comparative Examples A and B. All the foulant was collected as a slurry in a pail, as seen in FIG. 5d.

Unlike the chemical cleaning using QuickTurn™, there was no need for steam and there were no issues related to handling chemicals and disposal of wastes.

### Example 2

### FSU-2 Launder Wall Cleaning using a Method of an Embodiment of the Instant Invention

A second cleaning of the FSU-2 launder wall was carried out using water at 14° C., 2.2 MPag and at a rate of 5.2 kg/min. The distance between the tip of the nozzle and the wall was maintained at between 30.5 and 60.1 cm.

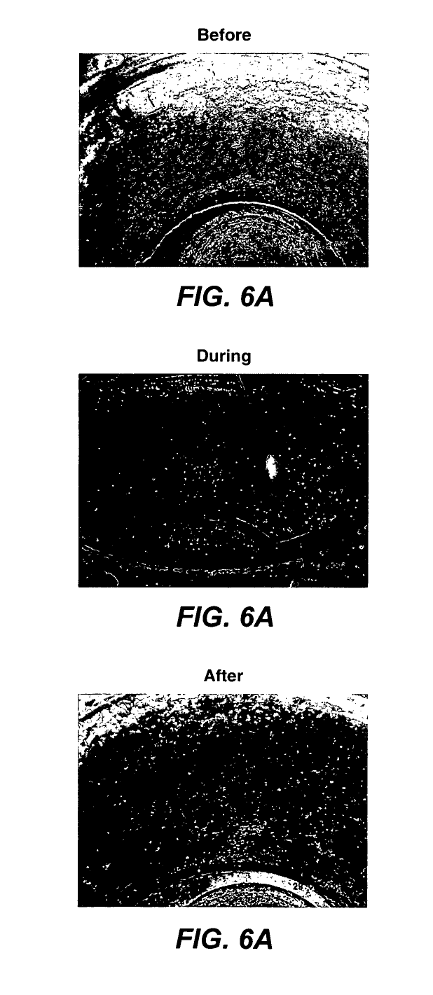

As in the first test, the launder wall was completely cleaned (as seen in FIG. 6c) in about 2 minutes. FIGS. 6a, 6b and 6c show the wall before, during and after cleaning, respectively. Once again, this cleaning time was significantly lower than the chemical cleaning and, unlike chemical cleaning, no rinsing by water was needed.

In both Examples 1 and 2, the launder wall was cleaned to the bare metal. Before cleaning, the average thickness of foulant was 5 mm and after cleaning the thickness was zero.

### Example 3

### FSU-2 and FSU-1 Vessel Wall Cleaning by a Method of an Embodiment of the Instant Invention

After successfully demonstrating the effectiveness of a method of an embodiment of the instant invention in cleaning the launder area of FSU-2, two more cleaning tests were performed on the inner wall of the settler pipe of FSU-2 and FSU-1 vessels, in that order.

The cleaning test conditions for the two vessels are shown in Table 1. It should be noted that FSU-1 has lower foulant thickness than FSU-2. The water pressure and water rate were the same and the water temperature was also very close (16 and 17° C.) in both tests.

TABLE 1
Cleaning Test Conditions for Example 3

| Conditions | FSU-2 | FSU-1 |
|---|---|---|
| Cleaning target | settler wall | settler wall |
| Pre-clean condition | ~7 mm foulant built | ~2-3 mm foulant built |
| | up over six weeks | up over six weeks |
| Nozzle | same as Examples 1 | same as Examples 1 |
| | and 2 | and 2 |
| Water T, ° C. | 17 | 16 |
| Water rate, kg/min | 4.9 | 4.9 |
| Water pressure, MPag | 2.1 | 2.1 |
| Cleaning direction | from bottom up | from bottom up |
| Time of cleaning, min | 7 | 7 |
| Result | cleaned to bare metal | cleaned to bare metal |

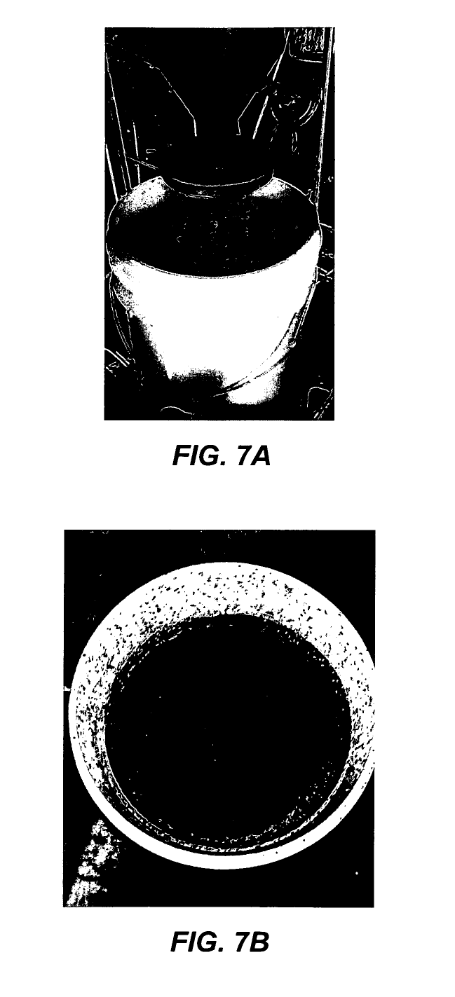

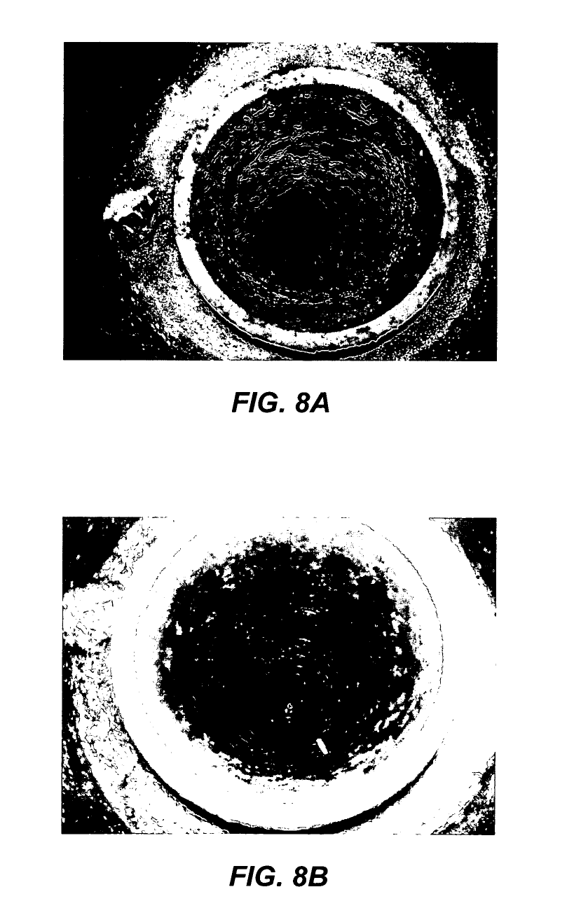

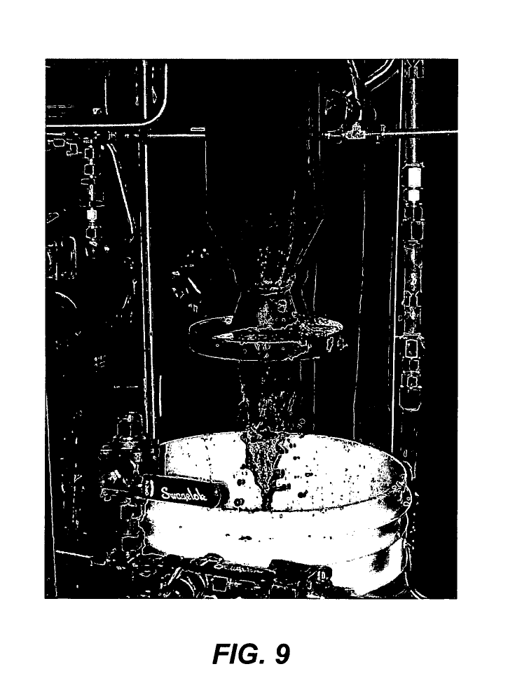

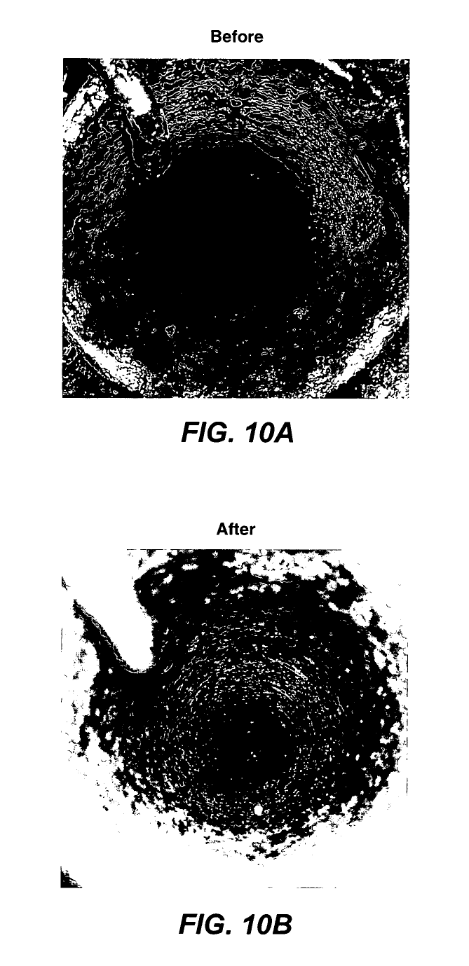

FIG. 7a shows effluent water from cleaning FSU-2 and FIG. 7b shows collected slurry from cleaning FSU-2. FIG. 8a shows the settler wall before cleaning FSU-2 and FIG. 8b shows the settler wall after cleaning FSU-2. FIG. 9 shows effluent slurry from cleaning FSU-1. FIGS. 10a and 10b show the settler wall before (FIG. 10a) and after (FIG. 10b) cleaning FSU-1.

The results shown in FIGS. 7 to 9 and listed in Table 1 illustrate that this process was effective at physically removing asphaltene comprising foulant from the walls of the FSUs.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

1. A method of removing at least a portion of foulant, the foulant comprising asphaltenes, from a surface of a vessel or conduit used in a paraffinic froth treatment (PFT) process, the method comprising spraying a liquid against the foulant to physically remove at least a portion of the foulant from the surface, wherein the liquid is a paraffinic solvent from the PFT process.

2. The method according to claim 1, wherein the paraffinic solvent is from a tailings solvent recovery unit (TSRU) used in the PFT process.

3. The method according to claim 1, wherein the paraffinic solvent is from a solvent recovery unit (SRU) used in the PFT process.

4. The method according to claim 1, wherein the paraffinic solvent is from a solvent storage unit used in the PFT process.

5. A method of removing at least of portion of foulant; the foulant comprising asphaltenes, from a surface of a vessel or conduit used in a paraffinic froth treatment (PFT) process, the method comprising spraying a liquid against the foulant to physically remove at least a portion of the foulant from the surface, wherein the liquid is a C₃ to C₅ paraffinic solvent.

6. A method according to claim 1, wherein the method is effected in the substantial absence of a foulant-dissolving agent.

7. The method according to claim 1, wherein the foulant comprises water, paraffinic solvent, inorganics, and non-volatile hydrocarbons comprising asphaltenes.

8. The method according to claim 1, wherein the foulant comprises 5-80 percent water and paraffinic solvent, 1-80 percent inorganics, 1-90 percent non-volatile hydrocarbons comprising asphaltenes, all by weight.

9. The method according to claim 1, wherein the foulant comprises about 46-50 percent water and paraffinic solvent, about 24-46 percent inorganics, and about 14-26 percent non-volatile hydrocarbons comprising asphaltenes, all by weight.

10. The method according to claim 1, wherein the foulant comprises between 7 and 40 percent asphaltenes, by weight.

11. The method according to claim 8, wherein the inorganics comprise, quartz, alumino-silicates, carbonates, FeₓS_{y}, where x is from 1 to 2 and y is from 1 to 3, and titanium-rich minerals.

12. The method according to claim 8, wherein more than 50% by number of the inorganics are present in particulates of less than 1 μm in size.

13. The method according to claim 1, wherein spraying is effected at a pressure of 0.2 to 8.0 MPag.

14. The method according to claim 1, wherein spraying is effected at a pressure of 1.5 to 4.0 MPag.

15. The method according to claim 1, wherein spraying is effected at a temperature of 0 to 100° C.

16. The method according to claim 1, wherein spraying is effected at a temperature of 1 to 30° C.

17. The method according to claim 1, wherein the method is effected in the substantial absence of steam injection.

18. The method according to claim 1, wherein the method further comprises removing foulant, which has been removed from the surface, from the vessel or conduit.

19. The method according to claim 1, wherein spraying is effected through nozzles in walls of the vessel or conduit.

20. The method according to claim 1, wherein spraying if effected from within the vessel's or the conduit's cavity outwardly toward the surface of the conduit or the vessel.

21. The method according to claim 1, wherein the PFT process is a low- or high-temperature process, characterized by a temperature of 15 to 100° C.

22. The method according to claim 1, wherein the vessel is a froth separation unit (FSU) used in the PFT process.

23. The method according to claim 22, wherein the surface is a launder area of the FSU.

24. The method according to claim 1, wherein the spraying is effected intermittently or continuously during partially suspended operation of the vessel or conduit.

25. The method according to claim 1, wherein the spraying is effected while operation of the vessel or conduit is suspended.

26. The method according to claim 24, further comprising spraying another liquid against the foulant on the surface while operation of the vessel or conduit is suspended to physically remove at least a portion of foulant from the surface.

27. The method according to claim 26, wherein the another liquid is the paraffinic solvent defined in any one of claims 2 to 5, or water.

28-62. (canceled)
